(19) United States
(12) Patent Application Publication
(10) Pub. No.: US 2010/0164979 A1
(43) Pub. Date: Jul. 1, 2010

(54) IMAGE FORMING APPARATUS AND IMAGE FORMING METHOD

(75) Inventor: Tomohiro Kawasaki, Osaka (JP)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: Kyocera Mita Corporation, Osaka (JP)

(21) Appl. No.: 12/572,465

(22) Filed: Oct. 2, 2009

(30) Foreign Application Priority Data
Dec. 26, 2008 (JP) 2008-333957
Dec. 26, 2008 (JP) 2008-333958
Jun. 5, 2009 (JP) 2009-135788

(51) Int. Cl. G09G 5/02

(52) U.S. Cl. 345/601

(57) ABSTRACT

An image forming apparatus includes a table storing unit that stores a first color Look Up Table; a table extracting unit that extracts the first color Look Up Table stored in the table storing unit; a table download unit that downloads a second color Look Up Table from an external storage medium; a table backup unit that stores the first color Look Up Table extracted by the table extracting unit in the external storage medium when the table download unit downloads the second color Look Up Table; and an image process unit that performs an image process based on the second color Look Up Table.

### INCORPORATION BY REFERENCE

This application is based upon and claims the benefit of priority from the corresponding Japanese Patent Application No. 2008-333957, filed Dec. 26, 2008, No. 2008-333958, filed Dec. 13, 2008, and No. 2009-135788, filed Jun. 5, 2009, the entire contents of which are incorporated herein by reference.

### BACKGROUND

1. Field of the Invention

The present invention relates to an image forming apparatus and an image forming method where the color conversion function is realized by downloading a color Look Up Table (hereinafter referred to as “color LUT”).

2. Description of the Related Art

Colors that may be reproduced by a color image forming apparatus vary depending upon a manufacturer or a model.

The prior art discloses an image forming apparatus capable of reproducing various colors by importing an external color LUT different from an installed color LUT. For example, a new color LUT may be imported to an image forming apparatus according to the following process. First, appropriate color LUTs are taken out from a service bulletin database of a maintenance provider in which various color LUTs are prepared, and a package to which a predetermined element (for example, attribute information) is appended is imported to a storage medium such as a universal serial bus (USB) memory. Then, a service person visits a user and downloads a new color LUT via a USB memory. An existing color LUT A is replaced by a new color LUT B, after which a print service based on the new color LUT becomes available to the user.

Further, there is disclosed an image forming apparatus provided with a plurality of color LUTs including an initial color LUT. On a conventional image forming apparatus, a plurality of color LUTs must be retained, and hence a considerable amount of memory space needs to be secured, which raises manufacturing costs. As the functionality of the apparatus becomes higher, the operation method becomes more complicated, and hence the apparatus must be handled by the service person.

Further, in comparison between entire output images before and after replacing a color LUT, it is difficult to visually recognize how a color has changed with clarity.

### SUMMARY

The present invention provides an image forming apparatus and an image forming method that are capable of simply and inexpensively switching back to an original color LUT, which has been considered to be difficult after switching to a new color LUT.

Further, the present invention provides an image forming apparatus and an image forming method that are capable of simply and smoothly performing a comparison of colors with those of an original color LUT, which has also been considered to be difficult after switching to a new color LUT.

An image forming apparatus according to an embodiment of the present invention comprises: a table storing unit that stores a first color LUT; a table extracting unit that extracts the first color LUT stored in the table storing unit; a table download unit that downloads a second color LUT from an external storage medium; a table backup unit that stores the color first LUT extracted by the table extracting unit in the external storage medium when the table download unit downloads the second color LUT; and an image process unit that performs an image process based on the second color LUT.

Further, an image forming apparatus according to another embodiment of the present invention comprises: a table storing unit that stores a first color LUT; a table download unit that downloads a second color LUT from an external storage medium; a table extracting unit that extracts the first color LUT stored in the table storing unit; a difference data generating unit that generates difference data between the first color LUT and the second color LUT; a table updating unit that stores the second color LUT and the generated difference data by overwriting the first color LUT stored in the table storing unit; a table restoring unit that restores the first color LUT stored to the table storing unit based on the second color LUT and the difference data.

Additional features and advantages are described herein, and will be apparent from the following Detailed Description and the figures.

### BRIEF DESCRIPTION OF THE FIGURES

In the accompanying drawings:

FIG. 1 is a block diagram illustrating a configuration of an image forming apparatus according to a first embodiment of the present invention;

FIG. 2 is a diagram illustrating an example of a color LUT converted for a download on the image forming apparatus according to the first embodiment of the present invention;

FIG. 3 is a plan view illustrating an example of an operation display unit (operation panel) of the image forming apparatus according to the first embodiment of the present invention;

FIG. 4 is a flowchart illustrating an operating procedure for the image forming apparatus according to the first embodiment of the present invention;

FIG. 5 is a sequence diagram illustrating a control flow according to the first embodiment of the present invention;

FIG. 6 is a conceptual diagram illustrating a procedure for replacing the color LUT on a conventional image forming apparatus;

FIG. 7 is a block diagram illustrating a configuration of an image forming apparatus according to a second embodiment of the present invention;

FIG. 8 is a data structure diagram representing an address space of a table data file after an update on the image forming apparatus according to the second embodiment of the present invention;

FIG. 9 is a first plan view illustrating an example of an operation display unit of the image forming apparatus according to the second embodiment of the present invention;

FIG. 10 is a second plan view illustrating an example of the operation display unit of the image forming apparatus according to the second embodiment of the present invention;

FIG. 11 is a first sequence diagram for describing a procedure for a printing control method according to the second embodiment of the present invention;

FIG. 12 is a second sequence diagram for describing the procedure for the printing control method according to the second embodiment of the present invention;

FIG. 13 is a third sequence diagram for describing the procedure for the printing control method according to the second embodiment of the present invention;

FIG. 14 is a block diagram illustrating a configuration of an image forming apparatus according to a third embodiment of the present invention;

FIGS. 15A to 15C are plan views illustrating examples of an operation display unit (operation panel) of the image forming apparatus according to the third embodiment of the present invention;

FIG. 16 is a flowchart illustrating an operating procedure for table replacing according to the third embodiment of the present invention;

FIG. 17 is a first sequence diagram illustrating an inter-device process related to the table switching according to the third embodiment of the present invention;

FIG. 18 is a second sequence diagram illustrating the inter-device process related to the table switching according to the third embodiment of the present invention; and

FIG. 19 is a third sequence diagram illustrating the inter-device process related to the table switching according to the third embodiment of the present invention.

### DETAILED DESCRIPTION

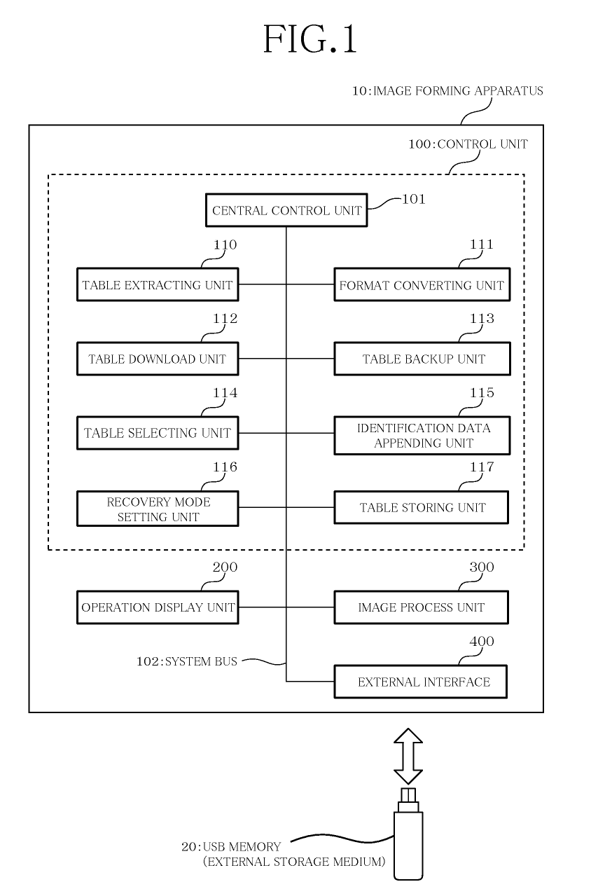

Hereinafter described is an image forming apparatus according to a first embodiment of the present invention with reference to FIGS. 1 to 5.

FIG. 1 is a block diagram illustrating a configuration of the image forming apparatus according to the first embodiment of the present invention. As illustrated in FIG. 1, an image forming apparatus 10 according to this embodiment includes a control unit 100 as a main component unit and other respective component units. A central control unit 101 includes a central processing unit (CPU), a read only memory (ROM), a random access memory (RAM), and a writable nonvolatile flash memory (such as an electrically erasable and programmable read only memory (EEPROM)). The central control unit 101 comprehensively controls the respective component units connected to a system bus 102 by executing software stored in the ROM. Further, the RAM functions as a work area useful for when the CPU performs each computing process. The flash memory mainly functions as a memory for storing a setting value for a device and other such information.

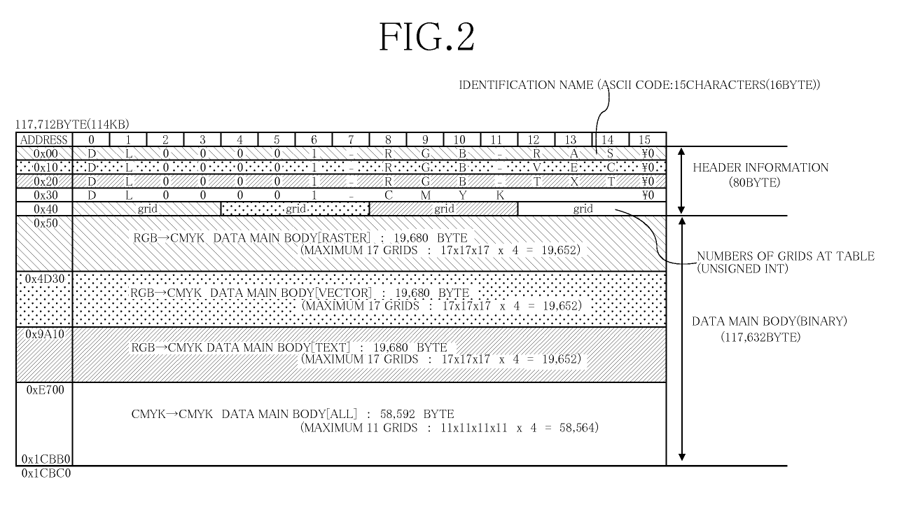

A table extracting unit 110 extracts an existing color LUT set for the image forming apparatus 10. In this embodiment, it is assumed that a table A is set as the existing color LUT. A format converting unit 111 converts the color LUT extracted by the table extracting unit 110 into a format for a download. As illustrated in FIG. 2, the format has a structure in which several kinds of color LUTs are collectively stored with predetermined header information and the like being appended thereto. Note that in the example of FIG. 2, the structure includes the following four color LUTs.

(1) RGB→CMYK (Raster)

A color LUT for converting raster data for an RGB-color bitmap image and the like into CMYK data.

(2) RGB→CMYK (Vector)

A color LUT for converting vector data for an RGB-color line, graphic, and the like into CMYK data.

(3) RGB→CMYK (Text)

A color LUT for converting RGB-color character data into CMYK data.

(4) CMYK→CMYK (All)

A color LUT corresponding to drawing data for each of raster, vector, and text.

A table download unit 112 downloads the color LUT from an external storage medium (USB memory) 20 via an external interface 400. The color LUT downloaded by the table download unit 112 is stored in a table storing unit 117, which includes a flash memory and the like, thereby updating the color LUT. Then, based on the color LUT after the update, an image process unit 300 prints print data.

A table backup unit 113 writes the color LUT converted by the format converting unit 111 to the external storage medium 20 via the external interface 400. Note that in this embodiment, the USB memory is used as an external storage medium, but the present invention is not limited thereto, and any other removable disk such as a Compact Disk Read Only Memory (CD-ROM) or a Digital Versatile Disk (DVD) may be used. The table backup unit 113 may be configured to access an external storage device through the intermediation of communication means via a communication cable such as a USB cable, a local area network (LAN) or the Internet.

A table selecting unit 114 selects the color LUT that a user wishes to use according to an input operation performed on an operation display unit 200. The color LUT specified by the user is selected from among a plurality of tables displayed on the operation display unit 200, and the table download unit 112 downloads the color LUT onto the image forming apparatus 10.

An identification data appending unit 115 appends predetermined identification data to the existing color LUT that has been converted by the format converting unit 111. A predetermined file name is used as the identification data, and date and/or time of appending the identification may be included. The file name may be used as a log, and unique identification data may be automatically appended to the color LUT, which allows the user to easily identify an original color LUT in the case that restoration is desired or otherwise.

A recovery mode setting unit 116 controls a backup performed by the table backup unit 113 according to the user's input operation. A recovery mode is normally enabled, but by turning off the recovery mode, it is possible to omit a write process with respect to the USB memory 20. By turning off the recovery mode, it is possible to realize a higher download speed, while by turning on the recovery mode, redundancy of data is enhanced. The user may set the recovery mode to “on” or “off” Note that on/off switching of the recovery mode is performed via the operation panel (operation display unit 200).

The table storing unit 117, which includes a nonvolatile memory or the like, stores a predetermined color LUT. The operation display unit 200 is an operation panel formed of a liquid crystal display, a touch panel, or the like. The table selecting unit 114 and the recovery mode setting unit 116 are provided with predetermined operation means, and are further adapted to display the file name (identification data) of the color LUT stored in the attached USB memory 20.

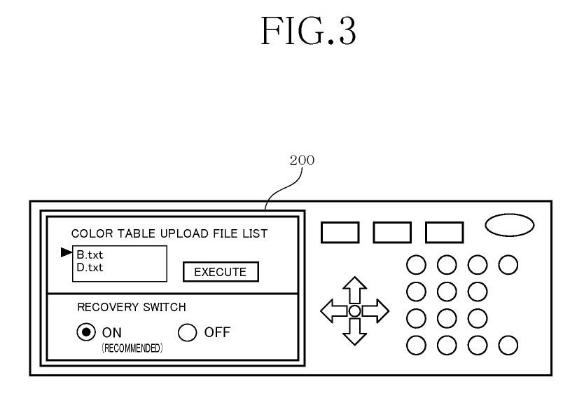

FIG. 3 is a plan view illustrating an example of the operation display unit 200 of the image forming apparatus according to this embodiment. FIG. 3 illustrates a screen display immediately after the USB memory 20 is attached, which indicates a state where a table B is selected by the user's operation with the recovery mode being selected to be “ON”. The image processing unit 300 performs a drawing process for the subject print data via the color LUT stored in the table storing unit 117.

The external interface 400 is an interface with respect to the external storage medium or the storage device, and in this embodiment, has a structure to which a removable medium such as a USB memory may be detachably attached. The external interface 400 may be any generic external interface with the external storage medium or the storage device via a wired or wireless connection.

The USB memory 20 is a removable medium that may be detachably attached to the image forming apparatus 10. Table format data that may be downloaded onto the image forming apparatus 10 may be stored in the USB memory 20. For example, as illustrated in FIG. 2, a plurality of kinds of color tables corresponding to formats (such as raster, vector, and text) of print data and color spaces (such as RGB and CMYK) on a color space basis may be stored.

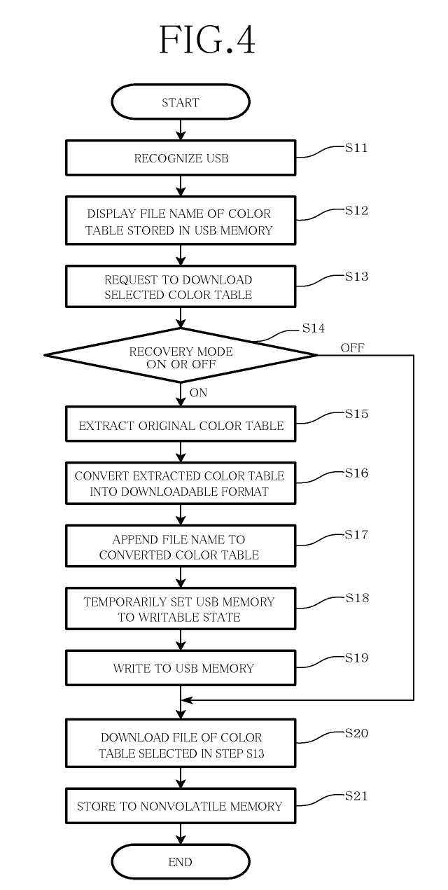

Described next is an image forming method performed by the image forming apparatus having such a configuration as described above by referring to FIG. 4. FIG. 4 is a flowchart illustrating an operating procedure for the image forming method according to this embodiment. First, it is assumed that the USB memory 20 is attached to the image forming apparatus 10. The external interface 400 of the image forming apparatus 10 detects that the USB memory 20 has been attached, which is then recognized by the central control unit 101 (S11).

The operation display unit 200 displays the file name of the color LUT stored in the USB memory 20 based on an instruction from the central control unit 101 (S12). The central control unit 101 extracts the file name of the color LUT stored in the USB memory 20, and passes the file name to the operation display unit 200.

According to the user's operation via the operation display unit 200, a download request for the specified color LUT within the USB memory 20 is made to the central control unit 101 (S13). For example, if such an input operation as illustrated in FIG. 3 is performed by the user, a request to download file data of the table B from the USB memory 20 is made to the central control unit 101.

It is determined whether or not the recovery mode has been set for the image forming apparatus 10 (S14). The central control unit 101 determines the setting of the recovery mode according to whether a recovery switch on the operation panel illustrated in FIG. 2 has been selected to be “ON” or “OFF”.

If it is determined in Step S14 that the recovery mode has been set (S14: ON), the table extracting unit 110 extracts the existing color LUT (S15). The format converting unit 111 converts the existing color LUT extracted in Step S15 into a predetermined downloadable format (S16). The identification data appending unit 115 appends the file name (identification data) to the converted color LUT (S17). Preferably, the date and/or time of appending the identification is included in the file name of the color LUT.

The central control unit 101 accesses the USB memory 20 to temporarily set the USB memory 20 to a writable state (S18), and the table backup unit 113 writes the existing color LUT to the USB memory 20 (S19). When the existing color LUT is written to the USB memory 20 in Step S19, the table download unit 112 executes a download of the color LUT selected in Step S13 (S20).

Note that if it is determined in Step S14 that the recovery mode has been set to off (S14: OFF), the above-mentioned Steps S15 to S19 are skipped, and the process continues at Step S20.

The central control unit 101 stores the newly-downloaded color LUT to the nonvolatile memory (table storing unit 117). The process of replacing the color LUT ends (S21).

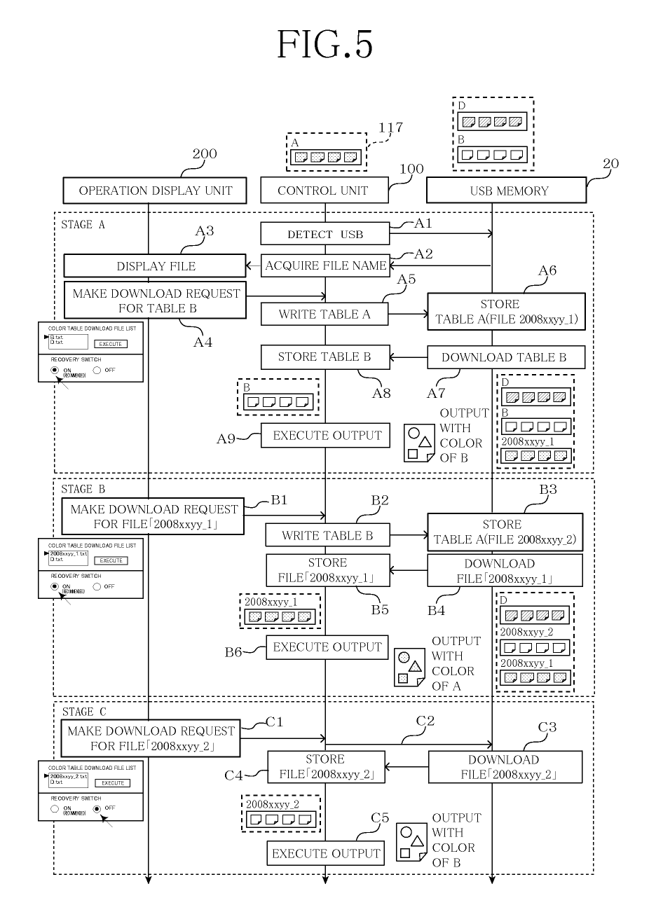

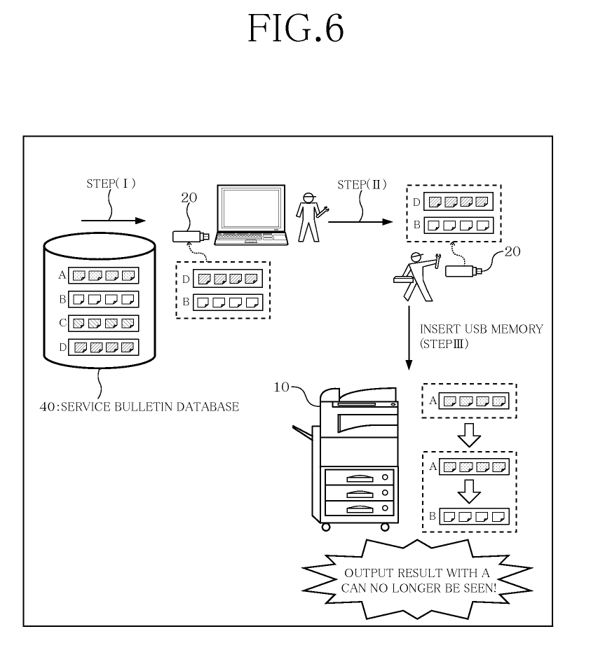

Described next is a control flow followed by the image forming apparatus according to this embodiment by referring to the drawings. FIG. 5 is a sequence diagram illustrating the control flow followed by the image forming apparatus according to this embodiment. FIG. 5 is divided into chronological stages, and Stage A, Stage B, and Stage C are described in the stated order.

As illustrated in FIG. 5, the color LUT of the table A is stored in the image forming apparatus 10, and the color LUTs of table B and table D are stored in the USB memory 20.

(Stage A)

Stage A is the stage occurring from the attaching of the USB memory 20 to completion of the replacement of the color LUT. As illustrated in FIG. 5, first, the central control unit 101 of the control unit 100 detects that the USB memory 20 has been attached (A1). The central control unit 101 acquires the file names of the color LUTs (B and D) stored in the USB memory 20, and notifies the operation display unit 200 of the file names (A2). The operation display unit 200 displays the file names of the tables B and D on the operation panel (A3).

Here, it is supposed that the operation display unit 200 has requested the control unit 100 to download the table B (A4). As illustrated in FIG. 5, the above-mentioned download request is executed by the user performing a panel operation. Further, here, the download request is made with the recovery switch being selected to be “ON”, and hence the recovery mode setting unit 116 sets the recovery mode to be enabled. That is, it becomes necessary to back up the table A to the USB memory 20.

The table backup unit 113 of the control unit 100 performs a process of writing the table A stored in the image forming apparatus 10 as the existing color LUT to the USB memory 20 (A5), and the table A is additionally stored to the USB memory 20 (A6). The identification data appending unit 115 appends an identifier with the date and/or time to the file name of table A. For example, in the case of FIG. 5, the file name “2008xxyy_{—}1” is appended to indicate the first backup data on “year of 2008/month of xx/day of yy”.

The table B stored in the USB memory 20 is downloaded onto the image forming apparatus 10 (A7), and stored to the table storing unit 117 (A8). On the image forming apparatus 10, the table A is replaced by the table B, and the USB memory 20 is brought to a state in which the file “2008xxyy_{—}1” (original table A) is stored in addition to the tables B and D. When a drawing output is executed in this state, the drawing output is performed based on the table B (A9).

(Stage B)

Stage B is the stage for restoring the table A (file “2008xxyy_{—}1”) downloaded to the USB memory 20 in Stage A. As illustrated in Stage B of FIG. 5, first, the operation display unit 200 is assumed to have made a request of the control unit 100 to download the file “2008xxyy_{—}1” (original table A) (B1). As illustrated in FIG. 5, the above-mentioned download request is executed by the user performing a panel operation.

In the same manner as in Stage A, the download request is made with the recovery switch being selected to be “ON”, and hence the recovery mode setting unit 116 sets the recovery mode to be enabled. That is, it is necessary to back up the table B to the USB memory 20. Therefore, the table backup unit 113 of the control unit 100 performs a process of writing the table B currently stored in the image forming apparatus 10 as the existing color LUT to the USB memory 20 (B2), and the table B is additionally stored to the USB memory 20 (B3). At this time, the identification data appending unit 115 appends the file name “2008xxyy_{—}2” that indicates the second backup data on “year of 2008/month of xx/day of yy” to the table B.

The file “2008xxyy_{—}1” (original table A) currently stored in the USB memory 20 is downloaded onto the image forming apparatus 10 (B4), and stored to the table storing unit 117 (B5). On the image forming apparatus 10, the table B is replaced by the table of the file “2008xxyy_{—}1”, and the original table A is restored. The USB memory 20 is brought to a state in which the file “2008xxyy_{—}2” (original table B) is stored in addition to the tables B and D and the file “2008xxyy_{—}1” (original table A). When the drawing output is executed in this state, the drawing output based on the color LUT of the file name “2008xxyy_{—}1”, in other words, the original table A is reproduced (B6).

(Stage C)

Stage C is the stage for restoring the color LUT of the file name “2008xxyy_{—}2” (original table B) downloaded to the USB memory 20 in Stage B. As described later, the control flow in Stage C is different from those in Stages A and B in that the recovery mode is set to “OFF”. As illustrated in FIG. 5, the operation display unit 200 is assumed to have made a request of the control unit 100 to download the file “2008xxyy_{—}2” (original table B) (C1). As illustrated in FIG. 5, the above-mentioned download request is executed by the user performing a panel operation. Here, the download request is made with the recovery switch being selected to be “OFF”, and hence the recovery mode setting unit 116 sets the recovery mode to be disabled. That is, the backup of the currently-set file “2008xxyy_{—}1” (original table A) is omitted. Therefore, the control unit 100 immediately performs the download request of the USB memory 20 for the file “2008xxyy_{—}2” (original table B) (C2).

In response thereto, the file “2008xxyy_{—}2” (original table B) currently stored in the USB memory 20 is downloaded onto the image forming apparatus 10 (C3), and stored to the table storing unit 117 (C4). On the image forming apparatus 10, the color LUT of the file “2008xxyy_{—}1” is replaced by the color LUT of “2008xxyy_{—}2”, and the restoration of the table B is completed. When the drawing output is executed in this state, the drawing output based on the file “2008xxyy_{—}2”, in other words, the table B is reproduced (C5).

As described above, the image forming apparatus 10 according to this embodiment comprises the table extracting unit 110 and the table backup unit 113, and is configured to store the color LUT data currently set on the image forming apparatus 10 to the USB memory 20 upon the replacement of the color LUT. Therefore, the original color LUT is automatically backed up. Accordingly, even if it becomes necessary to restore the original color LUT later, execution thereof may be performed with ease.

Further, the image forming apparatus 10 according to this embodiment comprises the recovery mode setting unit 116, which allows the restoration of the color LUT to be omitted. This makes it possible to achieve a higher download speed. Moreover, the image forming apparatus 10 according to this embodiment comprises the identification data appending unit 115, which may facilitate identification upon the restoration of the color LUT.

### Second Embodiment

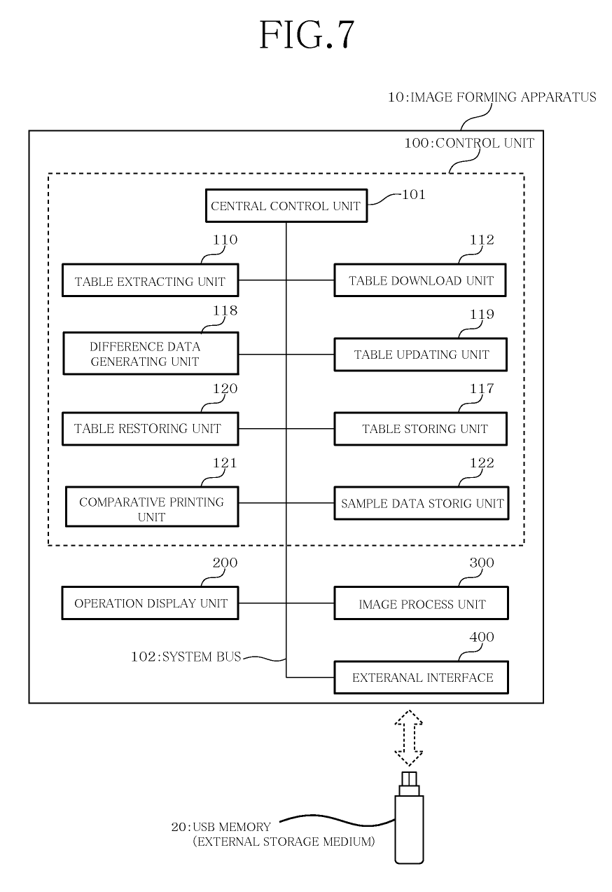

Described next is an image forming apparatus according to another embodiment of the present invention. FIG. 7 is a block diagram illustrating a configuration of an image forming apparatus according to a second embodiment of the present invention. As illustrated in FIG. 7, the image forming apparatus 10 according to this embodiment comprises the control unit 100 as the main component unit and other respective component units. Of the respective component units, description of the same component units as in the first embodiment is omitted.

A difference data generating unit 118 determines difference data between an original color LUT before an update which has been extracted by the table extracting unit 110 and a color LUT for an update which has been downloaded from the USB memory 20 by the table download unit 112. A subtraction process is performed on each input color value (for example, RGB value) and each output color value (for example, CMYK value) that form the color LUTs to calculate the difference data. In the case where the original color LUT is set as A and the color LUT for an update is set as B, difference data Δ may be calculated by the following expression (1).

(difference data Δ)=(color LUT B for an update)−(original color LUT A) (1)

A table updating unit 119 stores a data file formed of the color LUT for an update and the difference data by overwriting the color LUT stored in the table storing unit 117 with the data file. The update is performed on the color LUT set for the image forming apparatus 10.

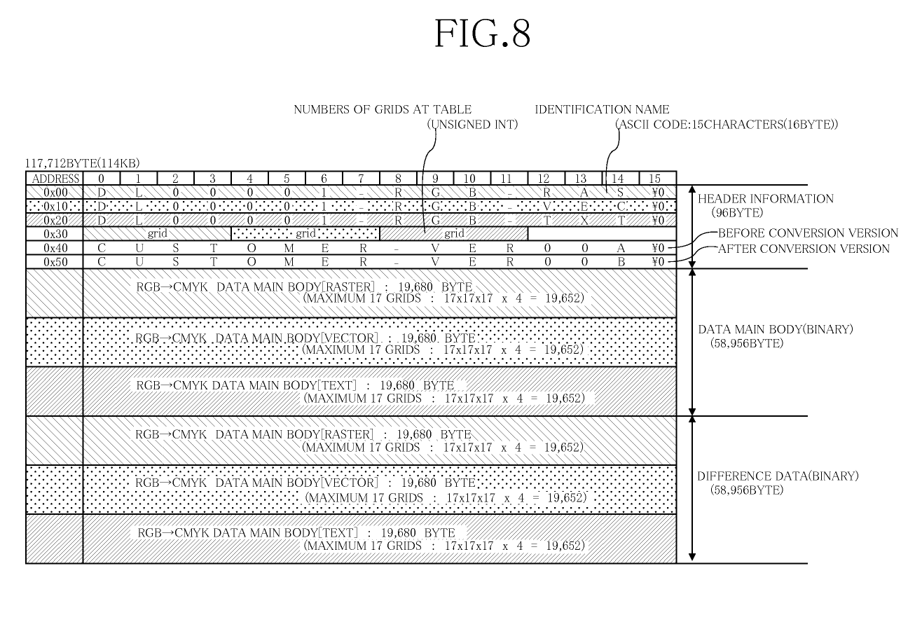

FIG. 8 is a data structure diagram representing an address space for the table storing unit 117 after the update performed by the table updating unit 119. As illustrated in FIG. 8, a store area for the color LUT within the table storing unit 117 includes mainly a header information area, a data main body area, and a data difference area.

The header information area is an area in which attribute information related to a color LUT is stored. As illustrated in FIG. 8, for example, identification names of objects (raster, vector, and text) corresponding to the respective color LUTs stored in the data main area are stored at the addresses “0x00” to “0x20”. Further, the numbers of grids of the respective color LUTs are stored at the address “0x30”, and a version name of the color LUT before an update and a version name of the color LUT after the update are stored at the addresses “0x40” and “0x50”, respectively. The data main area is an area in which color LUT for raster, vector, and text are stored.

FIG. 8 illustrates a state in which the respective color LUTs after being updated by the table updating unit 119 are stored. The color LUT has a structure in which RGB data as the input color value is associated with CMYK data as the output color value. The data difference area is an area in which the difference data between an original color LUT before an update and a new color LUT after the update is stored. As illustrated in FIG. 8, difference data items corresponding to the respective color LUT for raster, vector, and text are stored. The difference data is used for the restoration of the original color LUT before an update.

A table restoring unit 120 restores the original color LUT before an update based on the color LUT after the update and the difference data that form the data file stored in the table storing unit 117. For example, the original color LUT (A) may be calculated by the following expression (2) corresponding to the above-mentioned expression (1).

(original color LUT A)=(color LUT B after the update)−(difference data Δ) (2)

The table storing unit 117 stores the color LUT, in which the input color value is associated with the output color value, to a memory or the like. In the configuration of this embodiment, the color LUT for an update which has been downloaded from the attached USB memory 20 is stored by overwriting the existing table. Then, to perform the overwriting and the storing by the color LUT for an update, the storing is performed by converting the difference data from the original color LUT into a file together with the color LUT.

A comparative printing unit 121 performs the printing based on the color LUT before an update and the printing based on the color LUT after the update together according to the user's operation. In particular, the comparative printing unit 121 according to this embodiment performs the printing based on the color LUT before an update and the printing based on the color LUT after the update on the color value corresponding to the difference data.

In actuality, the comparative printing unit 121 performs the printing based on the color LUT before an update and the printing based on the color LUT after the update only on the color value with the difference data exceeding a predetermined threshold value. That is, the printing is performed for only those colors that have been changed by the update of the color LUT. For the printing used for comparative printing, the printing is performed by using sample image data previously retained in a sample data storing unit 122 described later.

The sample image data corresponding to the difference data is extracted from the sample data storing unit 122, and the printing is performed on the extracted image. Accordingly, the user may easily perform a comparison between printing results before and after the update of the color LUT, and may instantaneously recognize a difference of the color. The sample data storing unit 122 is a storage unit that stores predetermined sample image data, and is used upon execution of the comparative printing unit 121 as described above.

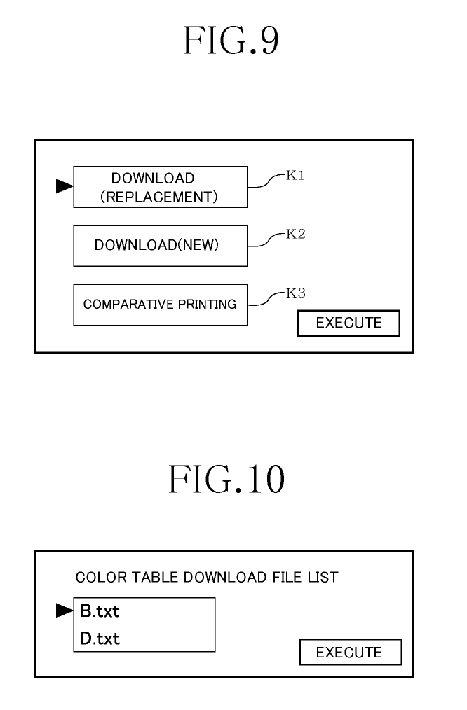

As illustrated in FIGS. 9 and 10, the operation display unit 200 provides display or operation means related to the download of the color LUT, and provides display or operation means related to the printing performed by the comparative printing unit 121.

FIGS. 9 and 10 are plan views illustrating examples of the operation display unit 200 of the image forming apparatus according to this embodiment. An operation display key K1 serves to request the download of the color LUT for an update, and request the retaining of the difference data from the original color LUT. In the case that the user selects the display key K1 to make the download request, the difference data is stored to the table storing unit 117 together with the color LUT downloaded from the USB memory 20, and a setting is performed to effect a state in which the original color LUT may be restored.

Meanwhile, an operation display key K2 serves to make the download request for the color LUT for an update. In this case, the difference data is stored as “0”, and is stored to the table storing unit 117 together with the downloaded color LUT for an update. Therefore, the display key K2 is selected for a case of a color LUT update that does not need the comparative printing later.

Further, an operation display key K3 serves to request the execution of the “comparative printing” performed by the comparative printing unit 121 as described above. If the operation display key K3 is selected, the current color LUT and the difference data that are stored in the table storing unit 117 are extracted, and the subtraction therebetween causes the original color LUT before the update to be restored. The comparative printing is carried out for only those colors that have been changed.

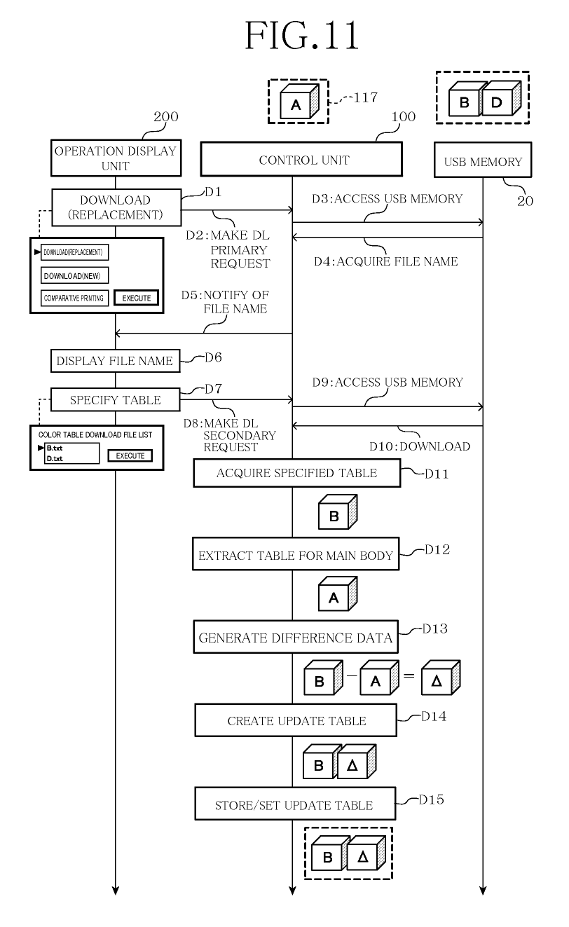

Described next is a printing control method for the image forming apparatus according to the second embodiment by referring to the drawings. FIGS. 11, 12, and 13 are sequence diagrams for describing a procedure for the printing control method according to this embodiment. FIGS. 11, 12, and 13 are divided into chronological stages, and Stage D, Stage E, and Stage F are described in the stated order.

(Stage D)

FIG. 11 is referenced to describe Stage D of the printing control method according to this embodiment. FIG. 11 is a sequence diagram representing an operating procedure for the case of selecting the operation display key K1 on an operation display screen illustrated in FIG. 9, in other words, of performing the selection or execution of the “download (replacement)”. Note that it is assumed that the table A is stored in the table storing unit 117 of the image forming apparatus 10, and the table B and the table D are stored in the USB memory 20 attached to the image forming apparatus 10.

The user (including a service person) is assumed to select and execute the “download (replacement)” request on the operation display unit 200 (D1). A download (DL) primary request is issued to the control unit 100 (D2). In response thereto, the control unit 100 accesses the USB memory 20 (D3) to acquire the file names of the color LUTs (B and D) stored in the USB memory 20 (D4).

The control unit 100 notifies the operation display unit 200 of the file names (D5), and the operation display unit 200 that has received the notification displays the file names of the color LUTs (B and D) (D6). The user specifies a file name of a desired color LUT from among the displayed file names (D7). It is assumed that the file data of the table B is specified as the desired color LUT.

The operation display unit 200 notifies the control unit 100 of a DL secondary request containing the specified file name of the color LUT (B) (D8). In response thereto, the control unit 100 accesses the USB memory 20 (D9) to acquire the specified table B by the download thereof from the USB memory 20 (D10). The external interface 400 of the image forming apparatus 10 acquires the specified table B that has been downloaded (D11). The table extracting unit 110 of the image forming apparatus 10 extracts the table A stored in the table storing unit 117 (D12).

The difference data generating unit 118 generates the difference data (Δ) by the subtraction between the table B acquired in Step D11 and the table A extracted in Step D12 (D13). The table updating unit 119 creates a file (B+Δ) of an update table by combining the difference data (Δ) generated in Step D13 and the table B acquired in Step D11 (D14), and stores the file to the table storing unit 117 (D15). The original table A is updated to the table B, and the difference data (Δ) between the table A and the table B is retained for performing the comparative printing described later.

(Stage E)

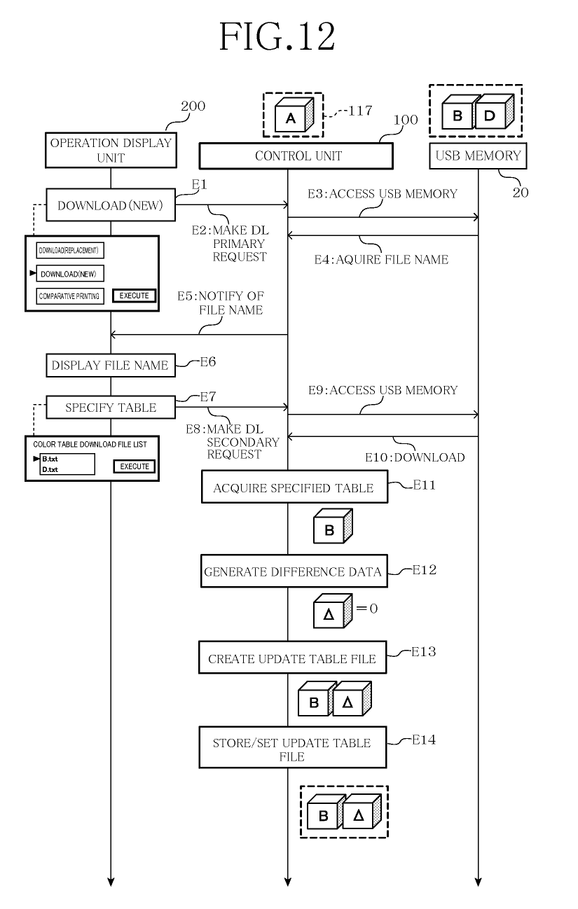

FIG. 12 is referenced to describe Stage E of the printing control method according to this embodiment. FIG. 12 is a sequence diagram representing an operating procedure for a case of selecting the operation display key K2 on the operation display screen illustrated in FIG. 9, in other words, of performing the selection or execution of the “download (new)”. Also in this stage, it is assumed that the table A is stored in the table storing unit 117 of the image forming apparatus 10, and the table B and the table D are stored in the USB memory 20 attached to the image forming apparatus 10.

The user (including a service person) is assumed to select and execute the “download (new)” request on the operation display unit 200 (E1). The download (DL) primary request is issued to the control unit 100 (E2). In response thereto, the control unit 100 accesses the USB memory 20 (E3) to acquire the file names of the color LUTs (B and D) stored in the USB memory 20 (E4). The control unit 100 notifies the operation display unit 200 of the file names (E5), and the operation display unit 200 that has received the notification displays the file names of the color LUTs (B and D) (E6). The user specifies a file name of a desired color LUT from among the displayed file names (E7). It is assumed that the file data of the table B is specified as the desired color LUT.

The operation display unit 200 notifies the control unit 100 of the DL secondary request containing the specified file name of the color LUT (B) (E8). In response thereto, the control unit 100 accesses the USB memory 20 (E9) to acquire the specified table B by the download thereof from the USB memory 20 (E10). The external interface 400 of the image forming apparatus 10 acquires the specified table B that has been downloaded (E11).

The difference data generating unit 118 generates the difference data (Δ) of zero (E12). Then, the table updating unit 119 creates the file (B+Δ) of the update table by combining the difference data (Δ) generated in Step E12 and the table B acquired in Step E11 (E13), and stores the file to the table storing unit 117 (E14). Accordingly, the original table A is updated to the table B, and the difference data (Δ) of zero is retained. For example, the difference data (Δ) of zero includes that the difference data in the data difference area in FIG. 8 is all zeros.

(Stage F)

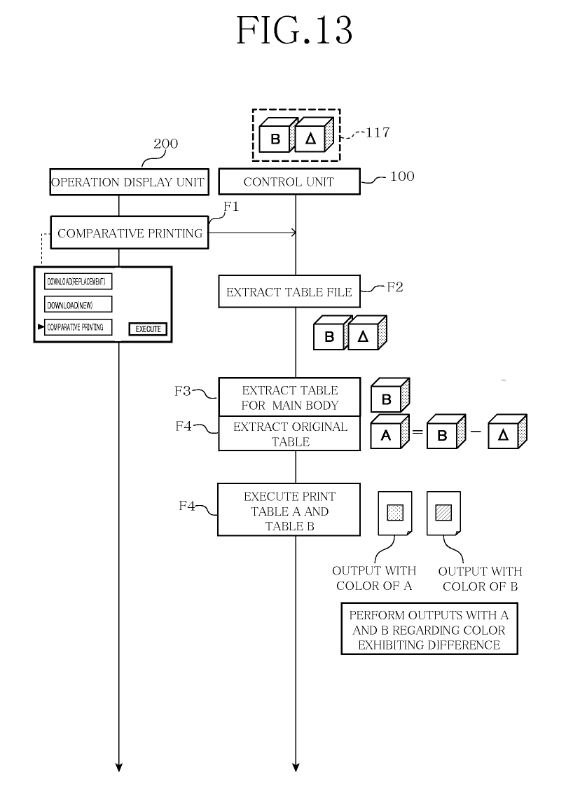

FIG. 13 is referenced to describe Stage F of the printing control method according to this embodiment. FIG. 13 is a sequence diagram representing an operating procedure for a case of selecting the operation display key K3 on the operation display screen illustrated in FIG. 9, in other words, of performing the selection or execution of the “comparative printing”. Successively to the operations described with reference to FIGS. 11 and 12, a table file formed of the table B and the difference data (Δ) is stored in the table storing unit 117 of the image forming apparatus 10. The user (including a service person) is assumed to select and execute the “comparative printing” request on the operation display unit 200 (F1). In response thereto, the table extracting unit 110 extracts the table file (B+Δ) stored in the table storing unit 117 (F2).

The table restoring unit 120 extracts the table B that constitutes the extracted table file (F3), and calculates the original table A by the subtraction between the table B and the difference data (Δ) (F4). Then, the comparative printing unit 121 prints sample data based on the table A, and prints those colors for which the color value has been changed based on the table B (F5). The printing based on the table A and the table B is performed only on the color value corresponding to the difference data. As described above, it is possible to download the color LUT for an update from the external storage medium or the like, and switch from the existing color LUT.

The difference data generating unit 118 determines the difference data between the color LUT before an update and the color LUT after the update. The table updating unit 119 updates the existing color LUT by storing the difference data and the color LUT for an update to the table storing unit 117. Therefore, the original color LUT before an update may be restored by the table restoring unit 120.

When an operation is performed, the comparative printing unit 121 may perform the printing based on the restored color LUT before an update and the printing based on the color LUT after the update. The comparative printing is performed by using the sample data for only those colors that have been changed by the update of the color LUT. Therefore, it is possible to perform a color comparison of the color LUTs before and after the update simply and quickly. The change of the color may be confirmed at a glance, and hence the image forming apparatus is easy to use for the user or the service person. Further, the image forming apparatus according to this embodiment is superior in operability and speed to a conventional image forming apparatus including a plurality of color LUTs.

### Third Embodiment

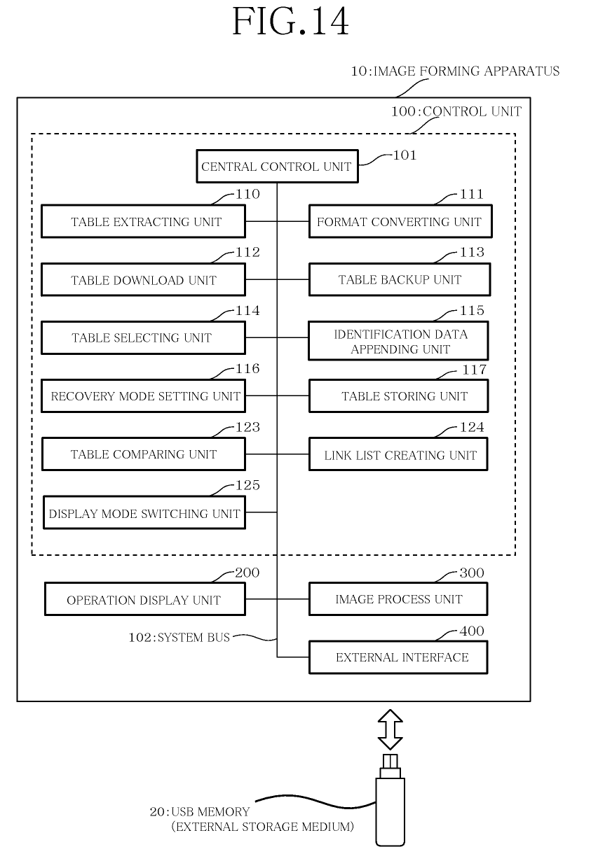

Described next is an image forming apparatus according to a third embodiment of the present invention by referring to FIGS. 14 to 19. FIG. 14 is a block diagram illustrating a configuration of the image forming apparatus according to this embodiment. This embodiment is different from the first embodiment in that upon switching the color LUT, the color LUT set for the main body of the image forming apparatus 10 is backed up only if a certain condition is satisfied. If the color LUT set for the main body of the image forming apparatus already exists in the USB memory 20, a backup process is omitted.

Other constituent elements are the same as those of the first embodiment, and hence detailed description thereof is omitted.

As illustrated in FIG. 14, the image forming apparatus 10 according to this embodiment further comprises, in the control unit 100: a table comparing unit 123, a link list creating unit 124; and a display mode switching unit 125. The table comparing unit 123 compares the color LUT set for the main body of the image forming apparatus 10 with the color LUT stored in the USB memory 20. The file name of the color LUT stored in the table storing unit 117 and the file name of the color LUT stored in the USB memory 20 are compared with each other, and it is determined whether or not there exists a matched file name. A link list (index data of the color LUT currently stored in the USB memory 20) described later may be used to smoothly perform the above-mentioned comparison.

The link list creating unit 124 creates the index data (hereinafter referred to as “link list”) of the color LUT by combining the file names of color LUTs currently stored in the USB memory 20. Therefore, by referencing the link list, it is possible to easily recognize the color LUT currently stored in the USB memory 20. Upon the comparison process performed by the table comparing unit 123, the link list may be used for extracting one comparison subject (the file name of the color LUT currently stored in the USB memory 20).

Each time a table switch is performed, the link list may include, in its structure, the file name of the color LUT set for the main body of the image forming apparatus 10 immediately before the switch. The file name may also include the date and/or time of the switch or the time of the update of the link list. The user may easily confirm a history of the table switching and the update of the link list. The link list is set for the main body of the image forming apparatus, or may include, in its structure, the file name of the color LUT that has been set. The user may easily confirm not only the color LUT currently set for the image forming apparatus 10 but also the color LUT set in the past.

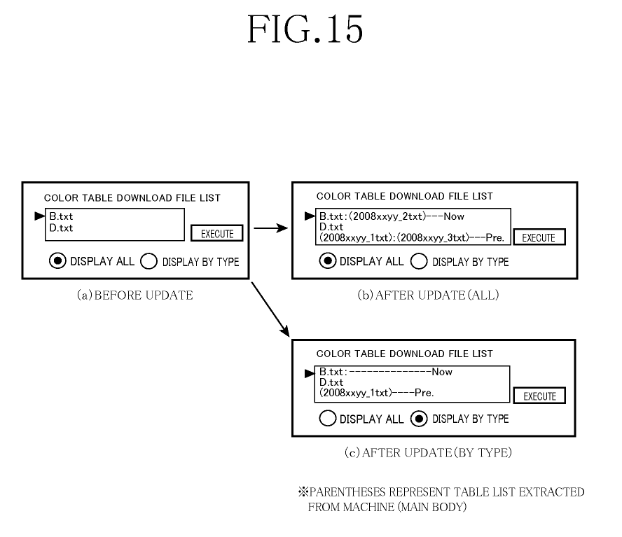

When the operation display unit 200 displays the link list, the display mode switching unit 125 switches the display method. As illustrated in FIGS. 15A to 15C, the display is switched according to the selection between “display all” and “display by type”.

For example, as illustrated in FIG. 15B, if “display all” is selected, all of the file names of the color LUTs that form the link list are displayed. In the case of FIG. 15B, the two file names (“B.txt” and “2008xxyy_{—}2txt”) are displayed regarding the table B, and hence, it is possible to know that the table switching has been performed regarding the table B at least once and the switching immediately before has been performed on year of 2008/month of xx/day of yy.

Meanwhile, as illustrated in FIG. 15C, if “display by type” is selected, the file names of the color LUTs that form the link list are displayed on a type basis. In the example of FIG. 15C, it is possible that only “B.txt” is displayed regarding the table B, and only “2008xxyy_{—}1txt” is displayed regarding the table A. Therefore, the type of the color LUT currently stored in the USB memory 20 may be recognized quickly.

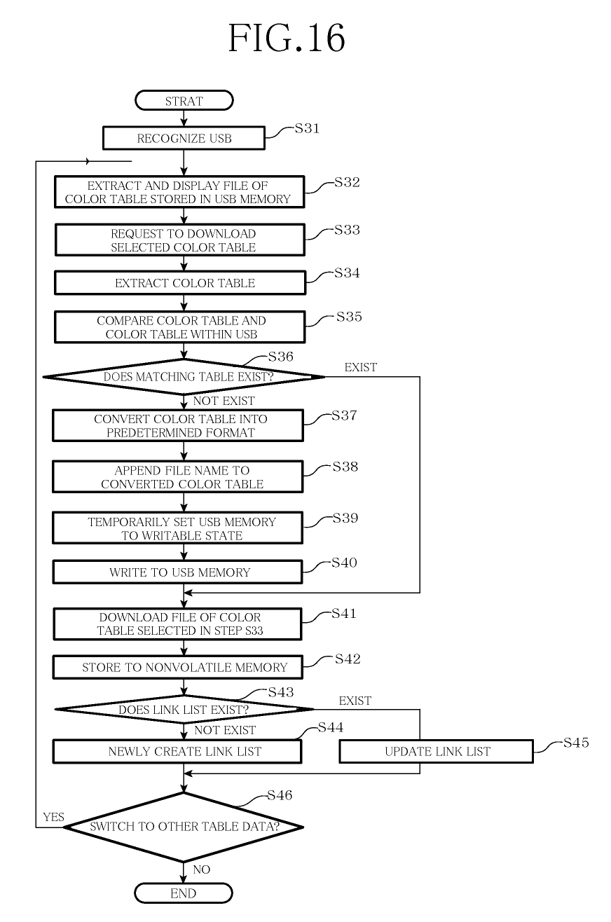

Described next is a table switching method performed by the image forming apparatus having such a structure as described above by referring to FIG. 16. FIG. 16 is a flowchart illustrating an operating procedure for the table switching method according to this embodiment. Described is a procedure performed immediately after the USB memory 20, in which the color LUTs (table B and table D) are stored, is attached to the image forming apparatus 10 according to this embodiment.

The central control unit 101 recognizes the attaching of the USB memory 20 via the external interface 400 (S31). The file name of the color LUT stored in the USB memory 20 is extracted and displayed by the operation display unit 200 (S32). If there is a link list, the extraction of the file name may be performed by analyzing the link list, and if there is no link list (for example, upon the first color LUT switch), the file name may be extracted directly from the header information or the like appended to the file.

According to an operation performed on the operation display unit 200, the download request for the color LUT selected by the user is made of the central control unit 101 (S33). The table extracting unit 110 extracts the color LUT currently set for the main body of the image forming apparatus 10(S34). The color LUT stored in the table storing unit 117 is extracted by the table extracting unit 110.

The table comparing unit 123 compares the color LUT (file name) set for the main body extracted in Step S34 and the color LUT (file name) within the USB memory 20 extracted in Step S32 (S35). If a matching color table does not exist (S36: not exist), the format converting unit 111 converts the color LUT set for the main body extracted in Step S34 into a predetermined format (S37). The identification data appending unit 115 appends the file name (identification data) to the converted color LUT set for the main body (S38). Date, time, and the like may be included in the file name. The central control unit 101 accesses the USB memory 20 to temporarily set the USB memory 20 to a writable state (S39), and the table backup unit 113 writes the color LUT set for the main body to the USB memory 20 (S40).

The table download unit 112 downloads the color LUT selected in Step S33 (S41). The central control unit 101 stores the downloaded color LUT to the nonvolatile memory (table storing unit 117) by overwriting the color LUT set for the main body (S42). Accordingly, the switching of the color LUT is performed.

The central control unit 101 determines whether the link list exists (S43). If a link list does not exist (S43: not exist), the link list creating unit 124 creates a new link list based on the file name of the color LUT currently stored in the USB memory 20 (S44). Meanwhile, if a link list exists (S43: exist), the link list creating unit 124 updates the link list (S45). The link list creating unit 124 creates a new link list by combining the original link list with the file name of the color LUT set for the main body or the file name of the color LUT newly backed up in the USB memory 20, and stores the new link list to the USB memory 20 by overwriting the existing link list.

To switch the color LUT again by downloading another color LUT from the USB memory 20 (S46: Yes), the procedure returns to Step S32 to perform the same process. Meanwhile, if the update to another color LUT is not to be performed (S46: No), the process ends.

If a matching color LUT exists in Step S36 (S36: exist), it is determined that there is no need for a backup, and the process of Step S41 is immediately performed. That is, the process of Steps S37 to S40 is skipped.

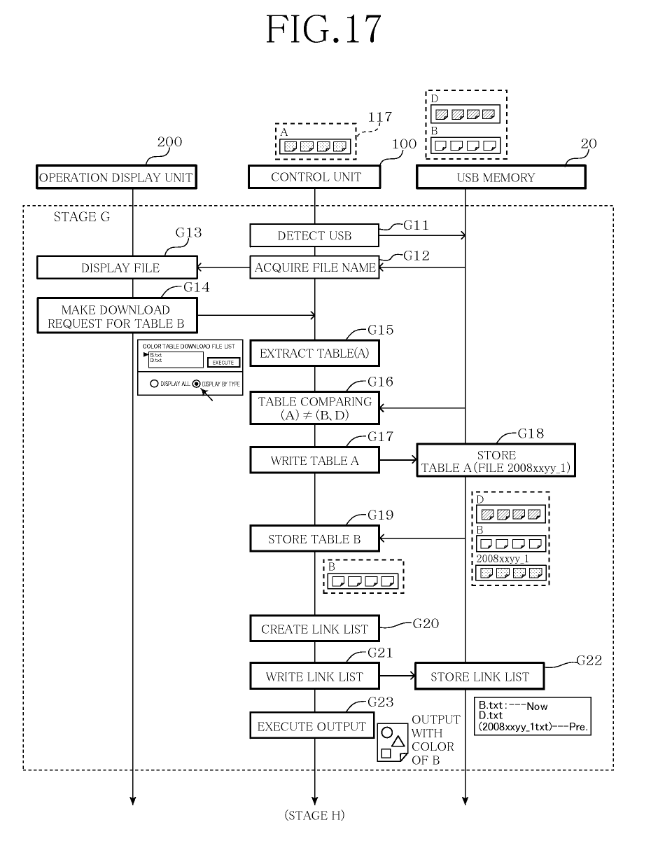

Described next is an inter-device process related to the table switching according to this embodiment by referring to the drawings. FIGS. 17 to 19 are sequence diagrams illustrating the inter-device process related to the table switching according to this embodiment. FIGS. 17 to 19 are divided into chronological stages, and Stage G, Stage H, and Stage I are described in the stated order. As illustrated in FIGS. 17 to 19, it is assumed that the table A is set for the image forming apparatus 10, and also that the tables B and D are stored in the USB memory 20 as the color LUTs that may be updated.

(Stage G)

FIG. 17 illustrates a procedure occurring from the attaching of the USB memory 20 up to completion of the switching of the color LUT. The central control unit 101 of the control unit 100 detects that the USB memory 20 has been attached (G11). The file names of the color LUTs stored in the USB memory 20 (table B and table D) are extracted, and the operation display unit 200 is notified thereof (G12).

The operation display unit 200 displays the file name (B.txt) of the table B and the file name (D.txt) of the table D on the operation panel (G13). The operation display unit 200 makes the download request of the control unit 100 for the table B by the user's operation (G14). As illustrated in a “color LUT download file list” field on the panel in Stage G of FIG. 17, “B.txt” is selected or executed to thereby notify the control unit 100 of the download request for the table B. As illustrated in FIG. 17, if “display by type” is selected, the color LUTs stored in the USB memory 20 may be displayed on a type basis.

The table extracting unit 110 of the control unit 100 extracts the table A currently stored in the table storing unit 117, in other words, the color LUT for the main body of the image forming apparatus 10 (G15). The table comparing unit 123 compares the file name of the table extracted in Step G15 and the file names of the tables extracted in Step G12 (G16). As a result, it is determined that the table A and the table B and the table D do not match each other.

The table backup unit 113 of the control unit 100 executes the write process for the table A (G17), with the result that the table A is additionally stored to the USB memory 20 (G18). The identification data appending unit 115 appends the identifier with the date or time being set as the file name to the table A, and then table A is stored to the USB memory 20. For example, in the case of FIG. 17, “2008xxyy_{—}1” that indicates the first backup data on “year of 2008/month of xx/day of yy” is appended as the file name.

The table B is downloaded from the USB memory 20 onto the image forming apparatus 10, and stored to the table storing unit 117 by overwriting table A currently stored in table storing unit 117 (G19). The color LUT on the image forming apparatus 10 is switched from the table A to the table B, and the file “2008xxyy_{—}1” (table A) is stored to the USB memory 20 in addition to the tables B and D.

The link list creating unit 124 creates a link list (G20). The link list is created by the table D and “2008xxyy_{—}1” that are the file names of the color LUTs stored in the USB memory 20. Further, the file name of the color LUT set for the main body may be combined therewith. The control unit 100 performs the process of writing the created link list to the USB memory 20 (G21), with a result that the link list is stored to the USB memory 20 (G22). When the output is executed in this state, the drawing output is executed based on the color of the table B specified by the user (G23).

(Stage H)

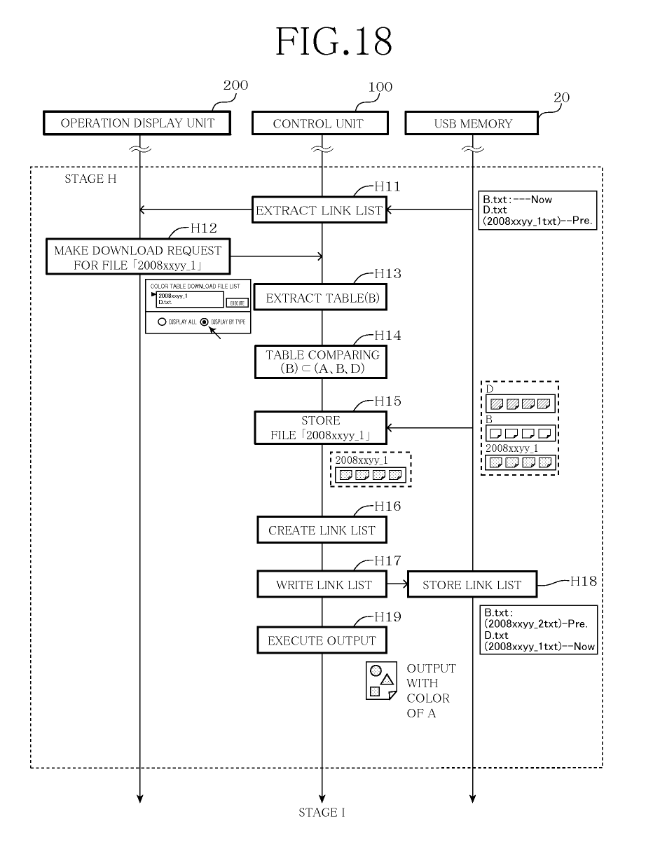

Stage H illustrates a procedure for switching the color LUT by the table A (file “2008xxyy_{—}1”) backed up in the USB memory 20 after the process of Stage G. As illustrated in FIG. 18, the control unit 100 extracts the link list from the USB memory 20, and notifies the operation display unit 200 thereof (H11). As illustrated in a “color LUT download file list” field on the panel of FIG. 18, the color LUTs (“2008xxyy_{—}1” corresponding to the table A and “D.txt” corresponding to the table D) stored in the USB memory 20 at this time point may be displayed on the operation display unit 200. Even when the color LUT is stored in the USB memory 20, if the same kind of color LUT is set for the image forming apparatus, the file name (“B.txt”) may also be prevented from being displayed.

The operation display unit 200 makes the download request of the control unit 100 for the file “2008xxyy_{—}1” (table A) by the user's operation (H12). The table extracting unit 110 of the control unit 100 extracts the table B stored in the table storing unit 117 (H13). The table comparing unit 123 compares the link list extracted in Step H11 with the table for the main body extracted in Step H13 (H14). It may determine that the table B is a match.

The control unit 100 causes the file “2008xxyy_{—}1” to be downloaded from the USB memory 20 without the process of writing the table B to the USB memory 20, and stores the file to the table storing unit 117 (H15). If color data to be backed up has already been stored in the USB memory 20 (if the matching table exists), a backup is determined as unnecessary and is not to be performed. The table B is replaced by the table A (corresponding to “2008xxyy_{—}1txt”) on the image forming apparatus 10.

The link list creating unit 124 creates the link list (H16). The link list may be created by combining the link list currently stored in the USB memory 20 and the file name (“2008xxyy_{—}2”) that would be appended if the color table (table B) set for the image forming apparatus 10 were backed up. The table backup unit 113 of the control unit 100 executes the write process for the link list (H17), with the result that the link list is updated (H18).

The identification data appending unit 115 appends the identifier with the date or time as the file name to the table A, and then table A is stored to USB memory 20. For example, in the case of FIG. 18, “2008xxyy_{—}1” that indicates the first backup data on “year of 2008/month of xx/day of yy” is appended as the file name. When the output is executed in this state, the drawing output based on the color of the table A is executed (H19).

(Stage I)

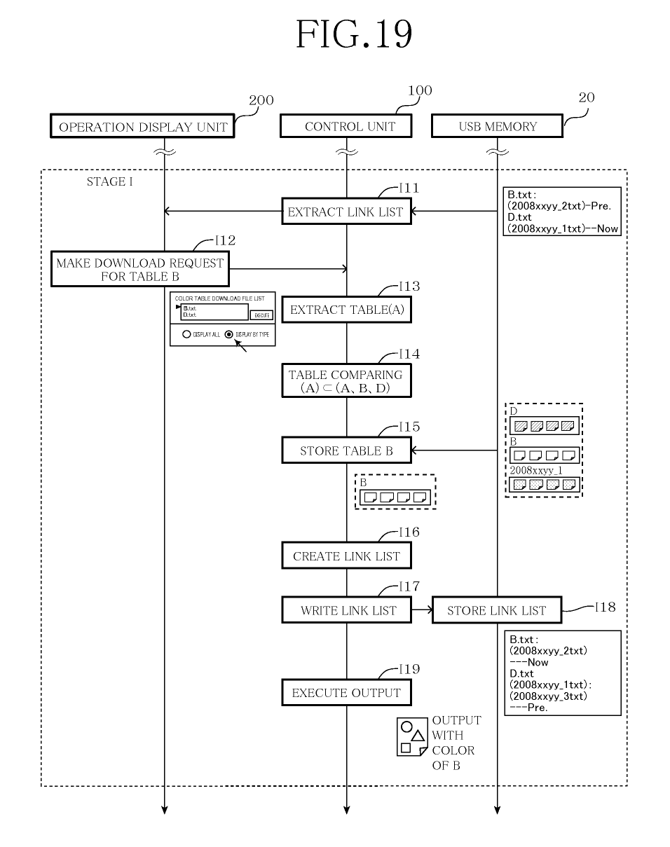

Stage I illustrates a procedure for switching the color LUT by the table B (file name “2008xxyy_{—}2”) backed up in the USB memory 20 after the process of Stage H. As illustrated in FIG. 19, the control unit 100 extracts the link list from the USB memory 20, and notifies the operation display unit 200 thereof (I11). The operation display unit 200 makes the download request of the control unit 100 for the file “2008xxyy_{—}2” (table B) by the user's operation (I12). The table extracting unit 110 of the control unit 100 extracts the file “2008xxyy_{—}1” (table A) stored in the table storing unit 117 (I13). The table comparing unit 123 compares the link list extracted in Step I11 and the table extracted in Step I13 (I14). As a result, it may be determined that the table A is a match.

The control unit 100 causes the file “2008xxyy_{—}2” to be downloaded from the USB memory 20 without the process of writing the file “2008xxyy_{—}1” to the USB memory 20, and stores the file to the table storing unit 117 (I15). The table A (corresponding to “2008xxyy_{—}1”) is replaced by the table B (corresponding to “2008xxyy_{—}2”) on the image forming apparatus 10.

The link list creating unit 124 creates the link list (I16). The link list may be created by combining the link list currently stored in the USB memory 20 and the file name (“2008xxyy_{—}3”) that would be appended if the color table (table A) set for the image forming apparatus 10 were backed up. The table backup unit 113 of the control unit 100 executes the write process for the link list (I17), with the result that the link list is updated (I18). When the output is executed in this state, the drawing output is executed based on the color of the table B (I19).

As described above, the image forming apparatus 10 according to the third embodiment of the present invention is configured to determine, prior to the backup of the color LUT to the USB memory 20, whether or not the same color LUT as the color LUT set for the image forming apparatus 10 is stored in the USB memory 20. If the same color LUT is stored in the USB memory 20, the backup is not to be performed. It is possible to eliminate waste of memory space of the USB memory 20 by eliminating redundantly occupied tables of the same type.

The link list creating unit 124 creates a link list as an index of the color LUTs stored in the USB memory 20, stores the link list to the USB memory 20, and updates the link list therein. The color LUT stored in the USB memory 20 may be easily recognized based on the link list, which may effectively prevent the same tables from being redundantly stored. Further, the link list may contain the file name of the color LUT set for the main body currently or immediately before. Even if the backup is not performed due to redundancy, the link list may contain the file name formed of date and/or time or the like.

Therefore, a table setting state, a table switching history, and the like with respect to the image forming apparatus 10 may be referenced.

Described above is an image forming apparatus according to the preferred embodiments of the present invention, but the image forming apparatus according to the present invention is not limited to the above-mentioned embodiments, and various changes may naturally be carried out within the scope of the present invention.

For example, the present invention may be applied to a general apparatus that performs color conversion for a color image. Examples include not only a copier, a printer, and a multifunction peripheral but also a facsimile machine and a scanner.

Further, the above-mentioned embodiments are directed to the replacement of the color LUT, but the present invention may be directed to the replacement of other such replaceable data or files, and may be further applied to a program and other such information process devices that perform data processing. For example, the present invention effectively operates in the case where an inconvenience occurs after upgrade or replacement of a program is performed.

The identification data appending unit 115 is configured to append the file name related to the date and/or time, but the present invention is not limited thereto. The file name may be appended based on various viewpoints and rules.

What is claimed is:

1. An image forming apparatus, comprising:
a table storing unit that stores a first color Look Up Table (LUT);
a table extracting unit that extracts the first color LUT stored in the table storing unit;
a table download unit that downloads a second color LUT from an external storage medium;
a table backup unit that stores the first color LUT extracted by the table extracting unit in the external storage medium when the table download unit downloads the second color LUT; and
an image process unit that performs an image process based on the second color LUT.

2. The image forming apparatus according to claim 1, wherein the external storage medium stores one or more color LUTs, the apparatus further comprising:
an operation display unit that displays identification data of the color LUTs stored in the external storage medium; and
a table selecting unit that selects identification data from among the displayed identification data of the color LUTs,
wherein the table download unit downloads the second color LUT to which the selected identification data is appended from the external storage medium.

3. The image forming apparatus according to claim 1, wherein the table backup unit may be disabled, the image forming apparatus further comprising a recovery mode setting unit that controls whether or not the table backup unit stores the first color LUT extracted by the table extracting unit in the external storage medium when the table download unit downloads the second color LUT.

4. The image forming apparatus according to claim 1, further comprising an identification data appending unit that appends identification data to the first color LUT extracted by the table extracting unit,
wherein the table backup unit stores the first color LUT to which the identification data is appended in the external storage medium when the table download unit downloads the second color LUT from an external storage medium.

5. The image forming apparatus according to claim 4, wherein the identification data appending unit appends at least one of a date and a time of appending the identification.

6. The image forming apparatus according to claim 1, further comprising a table comparing unit that compares the first color LUT stored in the image forming apparatus with the second color LUT stored in the external storage medium,
wherein the external storage medium stores one or more color LUTs, and
wherein the table backup unit avoids writing the first color LUT stored in the image forming apparatus to the external storage medium when the first color LUT stored in the image forming apparatus corresponds to at least one of the color LUTs stored in the external storage medium.

7. The image forming apparatus according to claim 6, further comprising a link list creating unit that creates a link list formed of identification data of the at least one of the color LUTs stored in the external storage medium,
wherein the table comparing unit compares the first color LUT stored in the image forming apparatus and the at least one of the color LUTs specified by the link list.

8. An image forming method, comprising:
a table extracting step of extracting a first color Look Up Table (LUT) that is stored in an image forming apparatus;
a table download step of downloading a second color LUT from an external storage medium;
a table backup step of storing the first color LUT to the external storage medium when the second color LUT is downloaded by the table download step; and
an image process step of performing an image process based on the second color LUT.

9. The method according to claim 8, wherein the external storage medium stores one or more color LUTs, the method further comprising:
a display step that displays identification data of the color LUTs stored in the external storage medium;
a selecting step of selecting identification data from among the displayed identification data of the color LUTs; and
a downloading step of downloading the second color LUT to which the selected identification data is appended from the external storage medium.

10. The method according to claim 9, further comprising:
an appending step of appending identification data to the first color LUT extracted by the table extracting unit; and
a storing step of storing the first color LUT to which the identification data is appended in the external storage medium when the second color LUT is downloaded by the table download step.

11. The method according to claim 10, wherein the identification data comprises at least one of a date and a time of appending the identification.

12. The method according to claim 8, wherein the external storage medium is a universal serial bus (USB) memory.

13. An image forming apparatus, comprising:
a table storing unit that stores a first color Look Up Table (LUT);
a table extracting unit that extracts the first color LUT stored in the table storing unit;
a table download unit that downloads a second color LUT from an external storage medium;
an image process unit that performs an image process based on the first color LUT stored in the table storing unit;
a difference data generating unit that generates difference data between the first color LUT and the second color LUT;
a table updating unit that stores the second color LUT and the generated difference data by overwriting the first color LUT stored in the table storing unit; and
a table restoring unit that restores the first color LUT stored to the table storing unit based on the second color LUT and the difference data.

14. The image forming apparatus according to claim 13, further comprising a comparative printing unit that performs a printing based on the second color LUT and a printing based on the first color LUT.

15. The image forming apparatus according to claim 14, wherein the comparative printing unit performs the printing of an image that includes a color value corresponding to the difference data.

16. The image forming apparatus according to claim 14, wherein the comparative printing unit performs the printing of an image that includes a color value with the difference data exceeding a predetermined threshold value.

17. The image forming apparatus according to claim 13, wherein the difference data is zero.

18. The image forming apparatus according to claim 14, further comprising a sample data storing unit that stores sample image data,
wherein the comparative printing unit extracts sample image data corresponding to the difference data from the sample data storing unit, and performs the printing of the extracted sample image data.

19. The image forming apparatus according to claim 13, wherein:
the difference data generating unit generates the difference data by subtracting the first color LUT from the second color LUT; and
the table restoring unit restores the first color LUT by subtracting the difference data from the second color LUT stored in the table storing unit.

20. The image forming apparatus according to claim 13, wherein the external storage medium is a universal serial bus (USB) memory.
